(19) United States
(12) Patent Application Publication
(10) Pub. No.: US 2016/0266053 A1
(43) Pub. Date: Sep. 15, 2016

(54) METHODS FOR MONITORING MOISTURE CONTENT IN A GASKET MATERIAL FOR USE IN A HIGH-PRESSURE CUBIC PRESS AND RELATED NONDESTRUCTIVE TESTING SYSTEMS

(71) Applicant: US Synthetic Corporation, Orem, UT (US)

(72) Inventors: C. Eugene McMurray, Galion, OH (US); Gene Bogdanov, Manchester, CT (US); Reinhold Ludwig, Paxton, MA (US)

(21) Appl. No.: 13/941,594

(22) Filed: Jul. 15, 2013

Related U.S. Application Data
(60) Provisional application No. 61/671,884, filed on Jul. 16, 2012.

(51) Int. Cl. G01N 22/04; F26B 3/00; C01B 31/06

(52) U.S. Cl. CPC G01N 22/04; C01B 31/06; F26B 3/00

(57) ABSTRACT

In various embodiments, a method for performing quality control on a gasket material for use in a cell assembly in a high-pressure cubic press is disclosed. In an embodiment, the method includes determining at least one physical characteristic of the gasket material using a nondestructive testing technique, and predicting a moisture content for the tested gasket material at least partially based on the at least one physical characteristic. In an embodiment, the method includes determining a dissipation factor for the gasket material using an electromagnetic energy frequency testing technique, and predicting a moisture content for the tested gasket material at least partially based on the dissipation factor and a dissipation factor-moisture content calibration curve for the gasket material.

### CROSS-REFERENCE TO RELATED APPLICATIONS

This application claims priority to U.S. Provisional Application No. 61/671,884 filed on 16 Jul. 2012, the disclosure of which is incorporated herein, in its entirety, by this reference.

### BACKGROUND

Wear-resistant, polycrystalline diamond compacts (“PDCs”) are utilized in a variety of mechanical applications. For example, PDCs are used in drilling tools (e.g., cutting elements, gage trimmers, etc.), machining equipment, bearing apparatuses, wire-drawing machinery, and in other mechanical apparatuses.

PDCs have found particular utility as superabrasive cutting elements in rotary drill bits, such as roller cone drill bits and fixed cutter drill bits. A PDC cutting element typically includes a superabrasive polycrystalline diamond layer commonly known as a polycrystalline diamond table. The polycrystalline diamond table is formed and bonded to a substrate using a high-pressure/high-temperature (“HPHT”) process. The PDC cutting element may be brazed directly into a preformed pocket, socket, or other receptacle formed in a bit body. The substrate may often be brazed or otherwise joined to an attachment member, such as a cylindrical backing A rotary drill bit typically includes a number of PDC cutting elements affixed to the bit body. It is also known that a stud carrying the PDC may be used as a PDC cutting element when mounted to a bit body of a rotary drill bit by press-fitting, brazing, or otherwise securing the stud into a receptacle formed in the bit body.

Conventional PDCs are normally fabricated by placing a layer of diamond particles adjacent to a surface of a cemented-carbide substrate and into a can assembly. The can assembly including the cemented-carbide substrate and layer of diamond particles therein may be surrounded by various different pressure transmitting media (e.g., salt liners), positioned in a graphite tube having graphite end caps disposed at respective ends of the graphite tube that forms a heater assembly, and finally embedded in a cube-shaped gasket medium (e.g., pyrophyllite). In an HPHT process used to form a PDC, anvils of an ultra-high pressure cubic press apply pressure to the cube-shaped gasket medium and the contents therein, while the cemented-carbide substrate and layer of diamond particles are controllably heated to a selected temperature at which sintering of the diamond particles is effected by passing a current through the graphite tube and end caps.

### SUMMARY

Embodiments of the invention relate to methods of monitoring moisture content in a gasket material used in HPHT processing of superabrasive elements in a high-pressure cubic press and related systems. The relationship between at least one physical characteristic of the gasket material (e.g., a dissipation factor) and moisture content for a gasket material may be exploited for use in a method for performing quality control on a gasket material and HPHT processing materials to form a superabrasive element such as a PDC.

In an embodiment, a method for performing quality control on a gasket material for use in a cell assembly in a high-pressure cubic press is disclosed. In an embodiment, the method includes determining at least one physical characteristic of the gasket material using a nondestructive testing technique, and predicting a moisture content for the tested gasket material at least partially based on the at least one physical characteristic. In an embodiment, determining at least one physical characteristic of the gasket material includes determining a dissipation factor for the gasket material using an electromagnetic (“EM”) energy testing technique (e.g., a radio frequency testing technique or other suitable frequency), and predicting a moisture content for the tested gasket material includes predicting the moisture content for the tested gasket material at least partially based on the dissipation factor and a dissipation factor-moisture content calibration curve for the gasket material.

In an embodiment, if the moisture content is below a threshold level, the gasket material may be formed into one or more components of a cell assembly, such as a cube and/or gasket plugs of the cell assembly. In an embodiment, if the moisture content is above a threshold level, the gasket material may be discarded and not employed as a gasket material for a cube and/or gasket plugs of a cell assembly. In another embodiment, if the moisture content is above a threshold level, the gasket material may be heated in a furnace to bake out the moisture therein to lower the moisture content. After heating or otherwise at least partially removing the moisture content, the processed gasket material may be re-tested to measure the dissipation factor thereof. If the moisture content is below the threshold level, then the re-tested gasket material may be employed for the cube and/or gasket plugs of a cell assembly.

In an embodiment, a nondestructive testing system for determining a moisture content in a gasket material for use in a high-pressure cubic press is disclosed. The nondestructive testing system includes a sensor configured to receive a gasket material for use in a cell assembly in a high-pressure cubic press. The nondestructive testing system further includes an EM energy source operably coupled to the sensor and configured to output excitation EM energy to be received by the sensor. The nondestructive testing system further includes a computing device operably coupled to the sensor to receive one or more signals output therefrom characteristic of a response of the sensor responsive to the sensor being excited by the excitation EM energy. The computing device may be configured to determine a moisture content of the gasket material at least partially based on the one or more signals.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is an isometric cutaway view of an embodiment of a cell assembly for containing a precursor assembly of a PDC to be HPHT processed.

FIG. 2 is an isometric view of an embodiment of a high-pressure cubic press with the cell assembly of FIG. 1 positioned to be compressed by six retracted anvils of the high-pressure cubic press.

FIG. 3 is a graph that depicts how cell pressure in the gasket material depends on material properties and explosive decompression of the gasket material may result under certain combinations of loading conditions and when gasket material has certain material properties.

FIG. 4 is a schematic diagram of an embodiment of a system for measuring moisture content in a gasket material using EM energy.

FIGS. 5 and 6 illustrate how moisture content in the gasket material alters a real part of the gasket material's permittivity (FIG. 5) and an imaginary part of the gasket material's permittivity (FIG. 6).

FIG. 7 is a cross-sectional view of an embodiment of a nondestructive testing system including a coaxial resonator sensor for use in practicing the moisture monitoring methods disclosed herein.

FIG. 8 is a graph of moisture content for a plurality of gasket material samples versus oven exposure time.

FIG. 9 is an embodiment of a dissipation factor-moisture content calibration curve depicting a relationship between the dissipation factor and moisture content for a given gasket material composition.

FIG. 10 illustrates a flow diagram according to an embodiment of a method of performing quality control on a gasket material.

FIG. 11 illustrates a flow diagram according to a more detailed embodiment of a method of performing quality control on a gasket material.

### DETAILED DESCRIPTION

Embodiments of the invention relate to methods of monitoring moisture content in a gasket material used in HPHT processing of superabrasive elements in an HPHT cubic press and related nondestructive testing systems for performing quality control on the gasket material. The relationship between at least one physical characteristic of the gasket material (e.g., a dissipation factor) and moisture content for a gasket material may be exploited for use in a method for performing quality control on a gasket material and HPHT processing materials to form a superabrasive element such as a PDC.

In an embodiment, a calibration curve or data for a relationship between the dissipation factor and moisture content in the gasket material may be developed and/or provided. A gasket material may be tested using an EM radiation technique (e.g., radio-frequency technique, a microwave radiation technique, an ultrasound technique, an x-ray technique, or combinations thereof) to measure a dissipation factor of the gasket material. The predicted moisture content for the tested gasket material may be determined at least partially based on the measured dissipation factor and/or the calibration curve.

In an embodiment, if the moisture content is below a threshold level, the gasket material may be formed into one or more components of a cell assembly, such as a cube and/or gasket plugs of the cell assembly. In an embodiment, if the moisture content is above a threshold level, the gasket material may be discarded and not employed as a gasket material for the cube and/or gasket plugs of the cell assembly. In another embodiment, if the moisture content is above a threshold level, the gasket material may be heated in a furnace, exposed to a reduced pressure (e.g., a vacuum), otherwise processed, or combinations thereof to remove at least some of the moisture therein to lower the moisture content. After processing or drying, the gasket material may be re-tested to measure the dissipation factor thereof. If the moisture content is below the threshold level, then the re-tested gasket material may be employed for the cube and/or gasket plugs of a cell assembly.

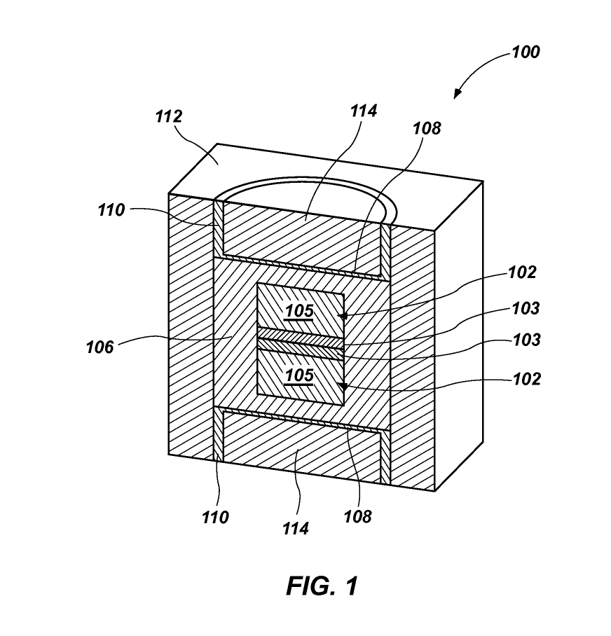

FIG. 1 is a cross-sectional view of an embodiment of a cell assembly 100 for containing one or more precursor assemblies 102 of a superabrasive element to be HPHT processed, such as a cobalt-cemented tungsten carbide substrate and a plurality of diamond particles thereon. For example, the superabrasive element may be a PDC. Examples of PCD elements and PDCs are disclosed in U.S. Pat. Nos. 7,516,804; 7,806,206; 7,866,418; 8,034,136; and 8,080,074, each of which is incorporated herein, in its entirety, by this reference. For example, the precursor assembly 102 may include a substrate 103 (e.g., a cobalt-cemented tungsten carbide substrate) and a diamond volume 105 (e.g., un-sintered diamond particles or an at least partially leached polycrystalline diamond body).

As shown in FIG. 1, the precursor assembly 102 is at least partially surrounded by a graphite heating element 104 (e.g., a tube), which is further at least partially surrounded by bushings 106 (e.g., salt bushings) and metal discs 108. First and second steel current rings 110 are disposed on each end of the precursor assembly 102 and are operable to pass current through the graphite heating element 104 via the metal disc 108 and an anvils (not shown) of the HPHT cubic press to heat the contents to be HPHT processed. A gasket material generally defines a cube 112 that receives the precursor assembly 102 in an opening formed therein, the steel current rings 110, and the graphite heating element 104. A gasket material plug 114 may disposed in each opening defined by the steel current rings. The gasket material for the cube 112 and the gasket material plugs 114 may comprise any suitable gasket material, such as any material disclosed in U.S. Pat. No. 6,338,754, which is incorporated herein, in its entirety, by this reference. Another example of a suitable material for the cube 112 and the gasket material plugs 114 is pyrophyllite, which is commercially available from Wonderstone Ltd. of South Africa. Pyrophyllite is a phyllosilicate mineral composed of aluminum silicate hydroxide. Of course, other embodiments for the cell assembly 100 is disclosed in U.S. Pat. No. 8,074,566 and U.S. patent application Ser. No. 13/736,403, each of which is incorporated herein, in its entirety, by this reference.

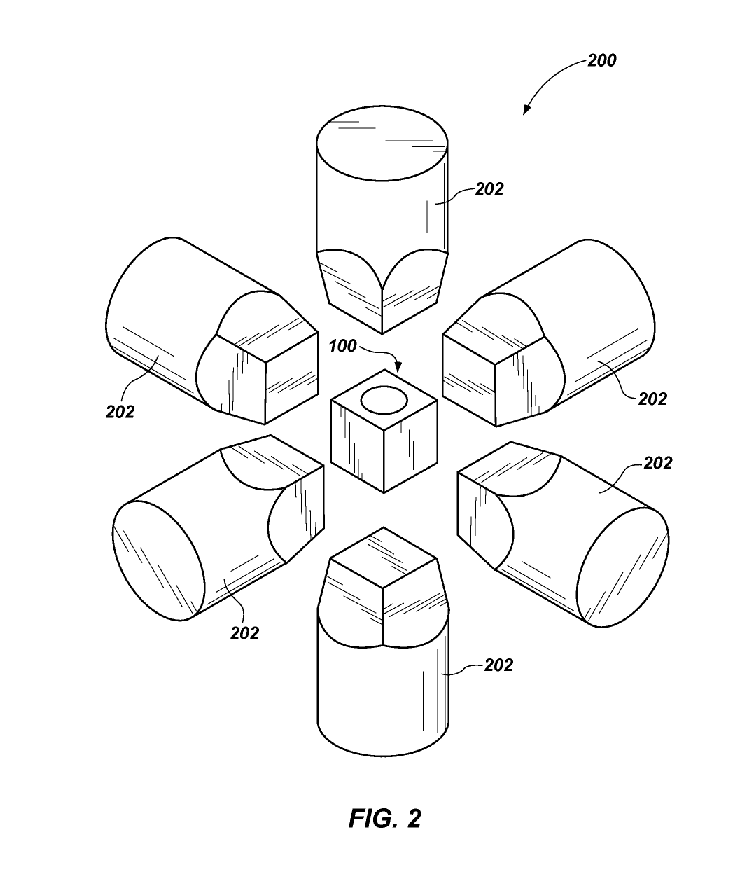

FIG. 2 illustrates an embodiment of an HPHT cubic press 200 with the cell assembly 100 of FIG. 1 positioned to be compressed by six retracted anvils 202 of the HPHT cubic press 200. The gasket material for the cube 112 and plugs 114 forms a seals against the anvils 202 during simultaneous loading by all six anvils 202 that allows pressure to be effectively transferred to the precursor assembly 102 to be HPHT processed.

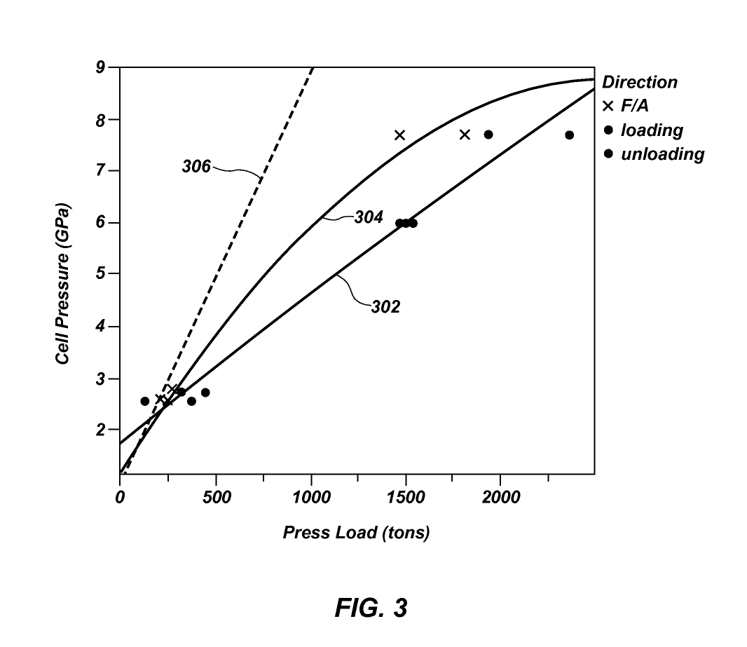

FIG. 3 is a graph 300 that depicts how cell pressure in the gasket material depends on material properties and explosive decompression of the gasket material may result under certain combinations of loading conditions and when gasket material has certain material properties. As explained further, increased moisture content in the gasket material may cause and/or facilitate the pressure seal provided by the gasket material to fail, thereby causing failure of the anvils 202 of the HPHT cubic press 200. In FIG. 3, straight line 302 is the loading line when the cube of gasket material is loaded by the anvils 202. Curved line 304 is the unloading curve, and the curvature of the curved line 304 is highly dependent on the moisture content in the gasket material. Straight line 306 is merely piston force driving the anvils 202 versus area of the anvil face. In one example, if the curved line 304 crosses the straight line 306, explosive decompression is believed to occur due to superheated steam embedded in the gasket material that is heated during HPHT processing of the cell assembly 100 being rapidly released during decompression. In other examples, moisture content in a cube may contribute to and/or cause decompression during any portion of an HPHT processs. In order to monitor moisture content in the gasket material, various embodiments of the invention for nondestructively testing the gasket material for moisture content are disclosed herein.

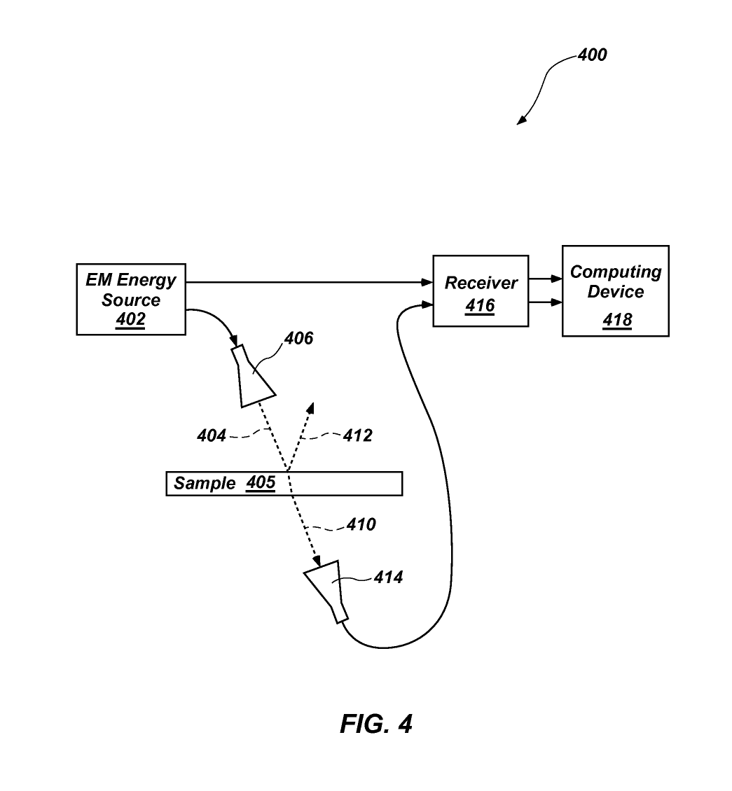

FIG. 4 is a schematic diagram of an embodiment of a nondestructive testing system 400 for monitoring moisture content in the gasket material using EM energy. An EM energy source 402 is provided that outputs EM energy wave 404 via a horn antenna 406. The EM energy wave 404 output by the horn antenna 406 may be transmitted through a gasket material sample 405 as a transmitted EM wave 410, while a portion of the EM energy wave 404 is also reflected and illustrated as a reflected EM wave 412. The transmitted EM wave 410 may be received by a horn antenna 414 and transmitted to a receiver 416, which is coupled to a computing device 418 (e.g., a desktop computer) that receives the signals from the horn antenna 414 and performs signal analysis on the received signals. For example, the computing device 418 may be a network analyzer. The EM energy may be microwave (“MW”) energy, radio frequency energy, ultrasonic EM radiation, x-rays, combinations thereof, or other suitable frequency of EM radiation.

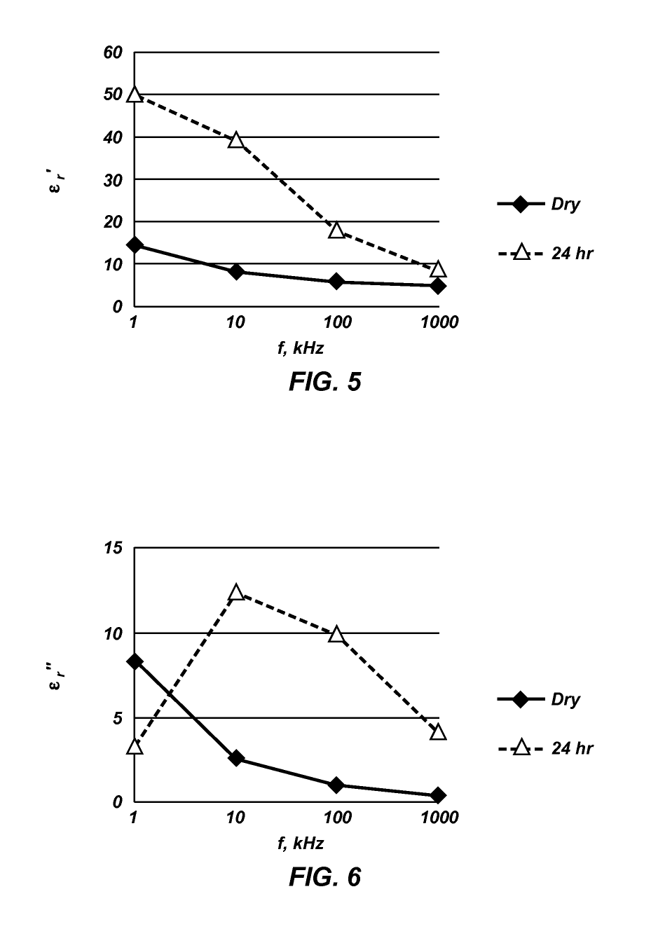

Attenuation of the EM energy wave 404 is indicative of moisture content of the gasket material sample, while phase shift between the EM energy 404 and the transmitted EM wave 410 is indicative of density of the gasket material sample. FIGS. 5 and 6 show how moisture content in the gasket material alters the real part of the gasket material's permittivity εᵣ′ (FIG. 5) and the imaginary part of the gasket material's permittivity εᵣ″ (FIG. 6). As shown in FIGS. 5 and 6, over a range of frequencies for the EM energy wave 404, the real and imaginary parts of the permittivity change for dry gasket material samples versus gasket material samples with about 0.5% moisture after exposure to air for 24 hours.

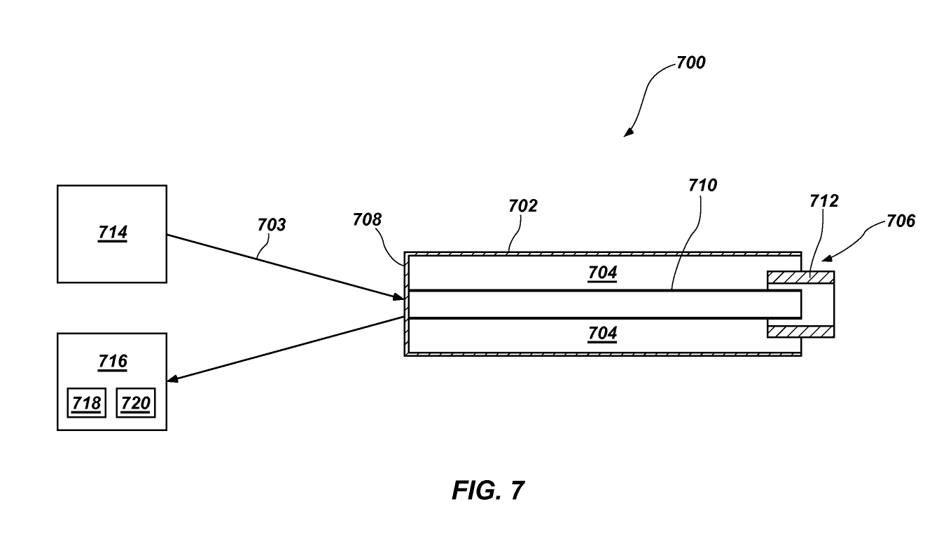

Other system configurations may be employed besides the nondestructive testing system shown in FIG. 4. For example, FIG. 7 illustrates an embodiment of a nondestructive testing system 700 including a coaxial resonator sensor 701 for use in practicing the moisture monitoring methods disclosed herein. The coaxial resonator sensor 701 includes an outer tubular body 702 defining a passageway 704 and including an open end 706 and a closed end 708. An inner tubular body 710 is disposed coaxially within the passageway 704 and coupled to the closed end 708. A gasket material sample 712 may be inserted about a portion of the inner tubular body 710 to reside at least partially within the passageway 704.

In the illustrated embodiment, the gasket material sample 712 is at least partially received in the passageway 704 of the coaxial resonator sensor 701 and the coaxial resonator sensor 701 is coupled to an EM energy source 714 (e.g., a MW energy source or a radio-frequency energy source) to receive an excitation signal output therefrom. The coaxial resonator sensor 701 receives an EM excitation energy 703 from the EM energy source 714 and the dissipated energy is output therefrom through the same input as the EM excitation energy to a computing device 716 (e.g., an analyzer) from which a Quality factor (“Q”) may be determined. The frequency of the EM excitation energy may be selected at or near a resonant frequency for the resonator. Q for the resonator changes when the gasket material sample 712 is disposed therein and further changes based on the moisture content of the gasket material sample 712. Thus, the value resonant frequency changes depending on whether the gasket material sample 712 is disposed in the passageway 704 and, consequently, the value of Q.

A dissipation factor (“D factor”) for the gasket material sample 712 may be determined based on the Q_{w/sample} for the coaxial resonator 701 having the gasket material sample 712 disposed therein and Q_{empty} for the coaxial resonator without the gasket material sample 712 disposed therein. For example, the D factor is equal to 1/Q_{w/sample}−1/Q_{empty}. It should be noted that the frequency of the received EM energy and the sensor design may be adjusted to at least one of the shape, size, properties of the gasket material, or to enhance the sensitivity and/or accuracy of the determination of the D factor.

In an embodiment, the computing device 716 includes at least one processor 718 and memory 720 storing computer executable instructions thereon. When the computer executable instructions are executed by the at least one processor 718, the at least one processor 718 may calculate the Q factors and further calculate the D factor based on the Q factors.

The relationship between the D factor and moisture content of the gasket material may be developed experimentally. The moisture content for a plurality of gasket material samples was determined and the results are shown in FIG. 8. The moisture content was controlled by the time of the gasket material sample was exposed in an oven. For each gasket material sample having a different known moisture content, the D factor was determined and a dissipation factor-moisture content calibration curve was developed for the D factor versus moisture content of the gasket material sample using the EM radiation testing technique discussed above. For example, the moisture content form each gasket material sample may be measured by weight gain/loss measurements.

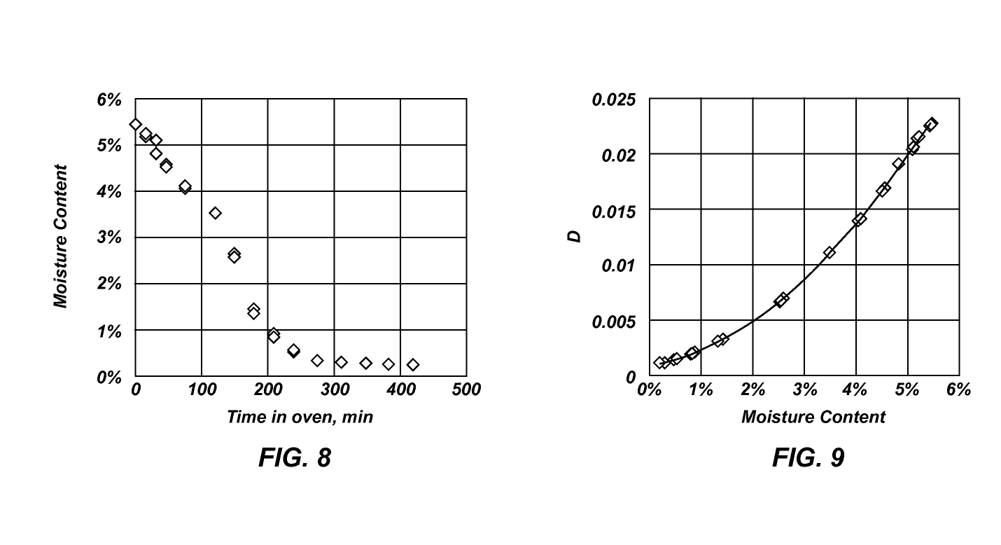

The dissipation factor-moisture content calibration curve is shown in FIG. 9. The inventors found based on the experimental data shown in FIG. 9, that the sensitivity to moisture content in the gasket material decreases at the lower moisture content levels. It should be noted that a particular calibration curve is dependent on the composition of the gasket material. Thus, for a different gasket material composition and/or structure, the calibration curve may change. The inventors currently believe that the sensitivity to moisture content in the gasket material is greater for reabsorbed moisture than for moisture (e.g., water) incorporated in the crystal structure of the gasket material (i.e., hydrated crystals).

The relationship between D factor and moisture content for the gasket material may be exploited as a method for performing quality control on a gasket material. In an embodiment, a calibration curve or data for the relationship between the D factor and moisture content in the gasket material may be developed. A gasket material may be tested using an energy dissipation technique as disclosed herein to measure the D factor thereof. The predicted moisture content for the tested gasket material may be determined based on the measured D factor and the calibration curve. For example, with reference to FIG. 7, the computer executable instructions are executed by the at least one processor 718, the at least one processor 718 may further determine the moisture content based on the calculated D factor and the calibration curve or data which may be stored in the memory 720 of the computing device 716.

In an embodiment, if the moisture content is above a threshold level, the gasket material may be scrapped and not employed as a gasket material for the cube or gasket plugs of a cell assembly. In an embodiment, if the moisture content is below a threshold level, the gasket material may be employed as a gasket material for the cube or gasket plugs of a cell assembly.

In another embodiment, if the moisture content is above a threshold level, the gasket material may be heated in a furnace, exposed to a reduced pressure (e.g., a vacuum), otherwise processed, or combinations thereof to remove at least a portion of the moisture therein to lower the moisture content. After processing, the gasket material may be re-tested to measure the D factor thereof. If the moisture content is below the threshold level, then the re-tested gasket material may be employed for the cube and/or gasket plugs of a cell assembly.

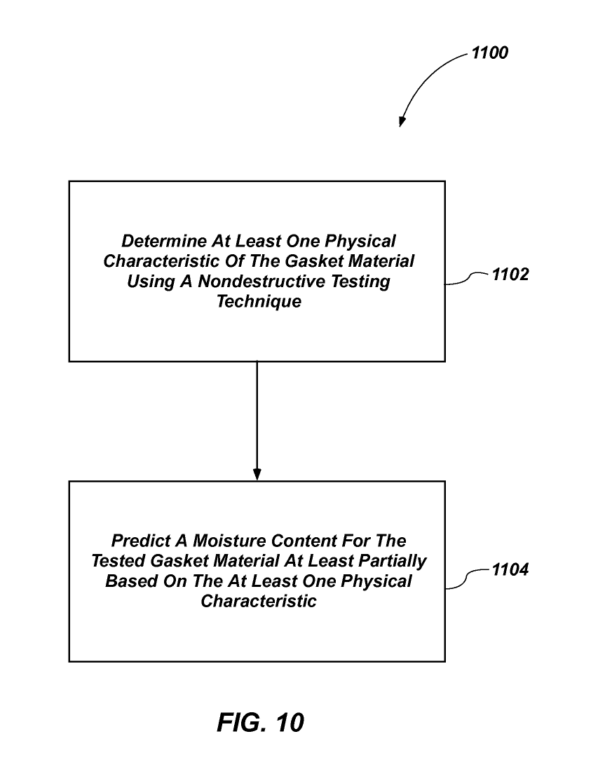

Referring to FIG. 10, in an embodiment, a method 1100 for performing quality control on a gasket material for use in a cell assembly in a high-pressure cubic press is disclosed. The method 1100 includes an act 1102 of determining at least one physical characteristic of the gasket material using a nondestructive testing technique, and an act 1104 of predicting a moisture content for the tested gasket material at least partially based on the at least one physical characteristic. In an embodiment, the act 1102 of determining at least one physical characteristic of the gasket material includes determining a dissipation factor for the gasket material using an energy dissipation testing technique (e.g., a radio frequency testing technique, a MW frequency testing technique, an ultrasound frequency testing technique, an x-ray testing technique, or combinations thereof), and the act 1104 of predicting a moisture content for the tested gasket material includes predicting the moisture content for the tested gasket material at least partially based on the dissipation factor and a dissipation factor-moisture content calibration curve for the gasket material. Referring to FIGS. 4 and 7, In an embodiment, the dissipation factor-moisture content calibration curve or data may be stored in the memory 720 of the computing device 716 (or computing device 418) and the at least one processor 718 of the computing device 718 (or computing device 418) is configured to access the dissipation factor-moisture content calibration curve or data stored in the memory 720, and calculate and predict the moisture content of the gasket material at least partially based on the measured dissipation factor and the dissipation factor-moisture content calibration curve or data.

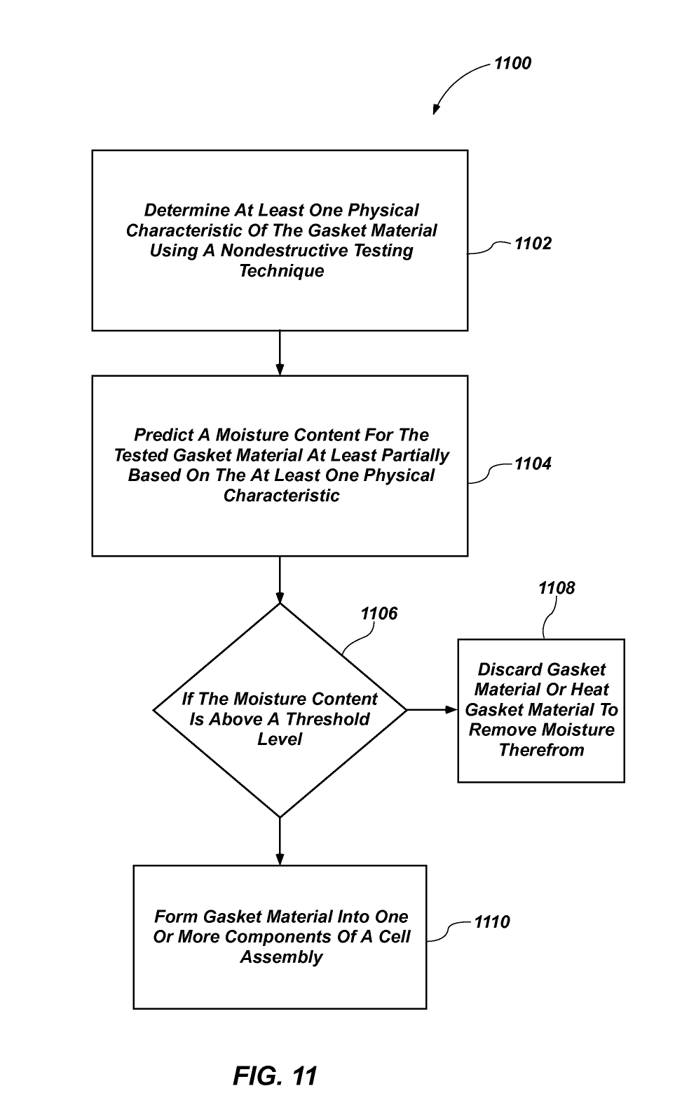

Referring to FIG. 11, in an embodiment, at 1106, if the moisture content is below a threshold level, the method 1100 further includes an act 1110 of forming the gasket material into one or more components of a cell assembly, such as a cube and/or gasket plugs of the cell assembly. For example, PDC precursor components, such as a cobalt-cemented tungsten carbide substrate and diamond powder may be enclosed in the cell assembly and HPHT processed to form a PDC.

In an embodiment, at 1106, if the moisture content is above a threshold level, the method 1100 further includes an act 1108 of discarding the gasket material and not employing it as a gasket material for a cube and/or gasket plugs of a cell assembly. In another embodiment, at 1106, if the moisture content is above a threshold level, the method 1100 further includes heating or otherwise processing the gasket material to remove at least some of the moisture therein to lower the moisture content. After processing, the gasket material may be re-tested to measure the dissipation factor thereof in accordance with acts 1102, 1104, and 1106. At 1106, if the moisture content is below the threshold level, then the re-tested gasket material may be employed for the cube and/or gasket plugs of a cell assembly in accordance with act 1110.

In another embodiment, the predicted moisture content from act 1104 may be correlated with another nondestructive analytical technique. For example, radio frequency energy may be used in act 1102, while the other nondestructive analytical technique may employ ultrasound or other type of energy.

The method 1100 of performing quality control discussed above may also be applied to other components of the cell assembly. For example, the method of performing quality control discussed above may also be applied to the heater, graphite parts, salt, or any other portion of the cell assembly, individually or in combination.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

What is claimed is:

1. A method for performing quality control on a gasket material for use in a cell assembly in a high-pressure cubic press, comprising:
determining at least one physical characteristic of the gasket material using a nondestructive testing technique; and
predicting a moisture content for the tested gasket material at least partially based on the at least one physical characteristic.

2. The method of claim 1, further comprising, if the moisture content is above a threshold level, discarding the tested gasket material.

3. The method of claim 1, further comprising, if the moisture content is above a threshold level, heating the tested gasket material to remove at least some moisture therefrom.

4. The method of claim 3, further comprising:
determining a dissipation factor for the gasket material that has been heated using a radio frequency testing technique; and
predicting a moisture content for the gasket material that has been heated at least partially based on the dissipation factor and a dissipation factor-moisture content calibration curve for the gasket material.

5. The method of claim 1, further comprising, if the moisture content is below a threshold level, forming the tested gasket material into one or more components of a cell assembly.

6. The method of claim 5 further comprising at least partially enclosing a diamond volume in the cell assembly having the one or more components, and subjecting the cell assembly and the diamond volume therein to a high-pressure/high-temperature process using the high-pressure cubic press.

7. The method of claim 6 wherein the diamond volume includes un-sintered diamond particles.

8. The method of claim 6 wherein the diamond volume includes a sintered polycrystalline diamond body.

9. The method of claim 1 wherein predicting a moisture content for the tested gasket material at least partially based on the dissipation factor and a dissipation factor-moisture content calibration curve for the gasket material includes calculating the moisture content using at least one processor.

10. The method of claim 1 wherein determining at least one physical characteristic of the gasket material using a nondestructive testing technique includes determining a dissipation factor for the gasket material using an electromagnetic radiation frequency testing technique.

11. The method of claim 10 wherein the electromagnetic radiation frequency testing technique includes a microwave frequency testing technique or a radio frequency testing technique.

12. A method for performing quality control on a gasket material for use in a cell assembly in a high-pressure cubic press, comprising:
determining a dissipation factor for the gasket material using an electromagnetic radiation frequency testing technique; and
predicting a moisture content for the tested gasket material at least partially based on the dissipation factor.

13. The method of claim 12 wherein the electromagnetic radiation frequency testing technique includes a microwave frequency testing technique or a radio frequency testing technique.

14. The method of claim 12, further comprising, if the moisture content is above a threshold level, discarding the tested gasket material.

15. The method of claim 12, further comprising, if the moisture content is above a threshold level, heating the tested gasket material to remove at least some moisture therefrom.

16. The method of claim 15, further comprising:
determining a dissipation factor for the gasket material that has been heated using a radio frequency testing technique; and
predicting a moisture content for the gasket material that has been heated at least partially based on the dissipation factor and a dissipation factor-moisture content calibration curve for the gasket material.

17. The method of claim 12, further comprising, if the moisture content is below a threshold level, forming the tested gasket material into one or more components of a cell assembly.

18. The method of claim 17 further comprising at least partially enclosing a diamond volume in the cell assembly having the one or more components, and subjecting the cell assembly and the diamond volume therein to a high-pressure/high-temperature process using the high-pressure cubic press.

19. The method of claim 18 wherein the diamond volume includes un-sintered diamond particles.

20. The method of claim 18 wherein the diamond volume includes a sintered polycrystalline diamond body.

21. The method of claim 12 wherein the gasket material is disposed in a cavity of a resonator, and wherein determining a dissipation factor for the gasket material using an electromagnetic radiation frequency testing technique is at least partially based on change in a quality factor of the resonator when the gasket material is disposed therein and when the gasket material is not disposed in the resonator.

22. The method of claim 12 wherein predicting a moisture content for the tested gasket material at least partially based on the dissipation factor includes calculating the moisture content using at least one processor.

23. The method of claim 12 wherein predicting a moisture content for the tested gasket material at least partially based on the dissipation factor includes accessing a dissipation factor-moisture content calibration curve from a memory device and calculating the moisture content using at least one processor.

24. The method of claim 12, further comprising correlating the predicted moisture content with another moisture-content testing technique other than radio frequency testing.

25. The method of claim 12 wherein predicting a moisture content for the tested gasket material at least partially based on the dissipation factor includes predicting the moisture content for the tested gasket material at least partially based on the dissipation factor and a dissipation factor-moisture content calibration curve for the gasket material.

26. A nondestructive testing system for determining a moisture content in a gasket material for use in a high-pressure cubic press, the nondestructive testing system comprising:
a sensor configured to receive a gasket material for use in a cell assembly in a high-pressure cubic press;
an electromagnetic energy source operably coupled to the sensor and configured to output excitation electromagnetic energy to be received by the resonator sensor; and
a computing device operably coupled to the sensor to receive one or more signals output therefrom characteristic of a response of the sensor responsive to the sensor being excited by the excitation electromagnetic energy, the computing device configured to determine a moisture content at least partially based on the one or more signals.

27. The nondestructive testing system of claim 26 wherein the sensor is configured as a resonator sensor.

28. The nondestructive testing system of claim 26 wherein the sensor is configured as a coaxial resonator sensor including an outer tubular body that receives an inner tubular body about which the gasket material is received.

29. The nondestructive testing system of claim 27 wherein the computing device includes memory storing a dissipation factor-moisture content calibration curve or data for the gasket material and at least one processor configured to calculate and predict the moisture content at least partially based on a measured dissipation factor and the dissipation factor-moisture content calibration curve or data.
